(19) United States
(12) Patent Application Publication
(10) Pub. No.: US 2007/0048644 A1
(43) Pub. Date: Mar. 1, 2007

(54) Method of preparing toner and toner prepared using the method

(75) Inventors: Jun-young Lee, Seoul (KR); Kyung-yol Yon, Seongnam-si (KR); Chang-kook Hong, Suwon-si (KR); Min-young Cheong, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/513,125

(22) Filed: Aug. 31, 2006

(30) Foreign Application Priority Data
Aug. 31, 2005 (KR) 10-2005-0080789

(51) Int. Cl. G03G 9/087

(52) U.S. Cl. 430/109.2; 430/137.17; 430/109.3

(57) ABSTRACT

A method of preparing a toner, includes: preparing a colorant dispersion by mixing a reactive emulsifying agent and a colorant; preparing a toner composition by mixing a macromonomer having a hydrophilic group, a hydrophobic group and at least one reactive functional group, at least one polymerizable monomer, and the colorant dispersion; emulsion polymerizing the toner composition in a medium; and separating and drying the polymerized toner. A toner prepared using the method, an image forming method using the toner, and an image forming apparatus using the toner are also provided. According to the method, the size, distribution and configuration of toner particles are easily controlled. In addition, the method minimizes a cleaning process, thereby decreasing the amounts of polluted water and waste water, which is very advantageous environmentally.

### CROSS-REFERENCE TO RELATED PATENT APPLICATION

This application claims the benefit of Korean Patent Application No. 10-2005-0080789, filed on Aug. 31, 2005, in the Korean Intellectual Property Office, the disclosure of which is hereby incorporated by reference in its entirety.

### BACKGROUND OF THE INVENTION

1. Field of the Invention

The present invention relates to a method of preparing a toner and to the toner prepared using the method. More particularly, the invention is also directed to a method of preparing a toner using a macromonomer and a reactive emulsifying agent in an emulsion polymerization process and to the resulting toner. The invention is further directed to an image forming process and an image forming apparatus employing the toner.

2. Description of the Related Art

In an electrophotographic process or an electrostatic recording process, a developer used to form an electrostatic image or an electrostatic latent image may be a two-component developer formed of a toner and carrier particles or a one-component developer formed of a toner only, without carrier particles. The one-component developer may be a magnetic one-component developer having magnetic properties or a nonmagnetic one-component developer not having magnetic properties. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toners include pulverization or polymerization processes. In the pulverization process, the toner is obtained by melt mixing synthetic resins with colorants and, if needed, other additives, pulverizing the mixture and classifying the particles until a desired size of particles is obtained. In the polymerization process, a polymerizable monomer composition is manufactured by uniformly dissolving or dispersing a polymerizable monomer, a colorant, a polymerization initiator and, if needed, various additives such as a cross-linking agent and an antistatic agent. The polymerizable monomer composition is then dispersed in an aqueous dispersive medium which includes a dispersion stabilizer using an agitator to form minute liquid drop particles. Subsequently, the temperature is increased and suspension polymerization is performed to obtain a polymerized toner having coloring polymer particles of a desired size.

In an image forming apparatus such as an electrophotographic apparatus or an electrostatic recording apparatus, an electrostatic latent image is formed through light-exposure on the surface of a photoreceptor which is uniformly charged. A toner is attached to the electrostatic latent image, and a resulting toner image is transferred to a transfer medium such as a paper through several processes such as heating, pressing, solvent steaming, etc. In most fixing processes, the transfer medium with the toner image passes through fixing rollers and pressing rollers, and the toner image is fused to the transfer medium by heating and pressing.

Improvements in preciseness and minuteness are required for images formed by an image forming apparatus such as an electrophotocopier. Conventionally, a toner used in an image forming apparatus is usually obtained using pulverization. When using pulverization, it is likely to form coloring particles with a wide range of particle sizes. Hence, to obtain satisfactory developer properties, there is a need to classify the coloring particles obtained through pulverization according to size to narrow the particle size distribution. However, it is difficult to precisely control the particle size distribution using a conventional mixing/pulverizing process in the manufacture of toner particles suitable for an electrophotographic process or electrostatic recording process. Also when preparing a minute particle toner, a toner preparation yield is low due to a classification process. In addition, there is a limit to a change/adjustment of a toner design for obtaining desirable charging and fixing properties. Accordingly, polymerized toners, in which the size of particles is easy to control and which do not need to go through a complex manufacturing process such as classification, have come into the spotlight recently.

When a toner is prepared using polymerization, the desired size distribution of particles is obtained without performing pulverization or classification.

U.S. Pat. No. 6,033,822 to Hasegawa et al. discloses a polymerized toner including a core formed of colored polymer particles and a shell covering the core in molecules, wherein the polymerized toner is prepared by suspension polymerization. However, it is still difficult to adjust the shape of the toner and the sizes of the particles. Also, the particle size distribution is wide.

U.S. Pat. No. 6,258,911 to Michael et al. discloses a bi-functional polymer having a narrow polydispersity and an emulsion-condensation polymerization process for manufacturing a polymer having covalently bonded free radicals on each of its ends. However, even when this method is used, a surfactant can cause an adverse effect, and it is difficult to control the size of the latex.

### SUMMARY OF THE INVENTION

The present invention provides a method of preparing a toner wherein the size of a toner particle is controlled freely and obtains a narrow particle size distribution.

The present invention also provides a toner having a small particle size and excellent storage property and durability, where the particle size of the toner can be easily controlled with a high yield.

The present invention also provides an image forming method where a high quality image can be fixed at a low temperature by using a toner having superior properties such as particle size control, storage property, and durability.

The present invention also provides an image forming apparatus where a high quality image can be fixed at a low temperature using a toner having superior properties in particle size control, storage property, and durability.

According to an aspect of the present invention, a method of preparing a toner is provided, including: preparing a toner composition by mixing a macromonomer having a hydrophilic group, a hydrophobic group and at least one reactive functional group, at least one polymerizable monomer, and a colorant dispersion, where the colorant dispersion is prepared by mixing a reactive emulsifying agent and a colorant; emulsion polymerizing the toner composition in a medium; and separating and drying the polymerized toner.

According to another aspect of the present invention, a method of preparing a toner, comprising: emulsion polymerizing a toner composition including a colorant dispersion, a macromonomer and at least one polymerizable monomer, wherein the colorant dispersion comprises a reactive emulsifying agent and a colorant and the macromonomer has a hydrophilic group, a hydrophobic group and at least one reactive functional group; and separating and drying the resulting polymerized toner.

According to another aspect of the present invention, a toner is provided including a copolymer of a macromonomer and a polymerizable monomer obtained by emulsion-polymerizing a toner composition in a medium, the toner composition including the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

According to another aspect of the present invention, a method of forming an image includes: forming a toner image by disposing a toner on an photoreceptor surface where an electrostatic latent image is formed; and transferring the toner image to a transfer medium, wherein the toner includes a copolymer of a macromonomer and a polymerizable monomer obtained by emulsion-polymerizing a toner composition in a medium, the toner composition including the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

According to another aspect of the present invention, an image forming apparatus includes: an organic photoreceptor; a unit for electrifying a surface of the organic photoreceptor; a unit for containing a toner prepared by the method of the present invention; a unit for supplying the toner to the surface of the organic photoreceptor to develop an electrostatic latent image on the surface of the organic photoreceptor into a toner image; and a unit for transferring the toner image on the surface of the organic photoreceptor to a transfer medium.

According to the present invention, a toner having a small particle size and excellent storage property and durability can be prepared. The particle size of the toner can be easily controlled. The toner is environment-friendly and can be produced through simplified processes at a low cost.

These and other aspects of the invention will become apparent from the following detailed description of the invention, which taken in conjunction with the annexed drawings, disclose various embodiments of the invention.

### BRIEF DESCRIPTION OF THE DRAWING

The above and other features and advantages of the present invention will become more apparent by describing in detail exemplary embodiments thereof with reference to the attached drawing in which:

FIG. 1 is a schematic diagram of an image forming apparatus employing a toner prepared using a method of an embodiment of the present invention.

### DETAILED DESCRIPTION OF THE INVENTION

According to the present invention, a colorant dispersion is prepared by mixing a reactive emulsifying agent and a colorant, a toner composition is prepared by mixing a macromonomer, a polymerizable monomer, and the colorant dispersion, and then the toner composition is emulsion polymerized.

During the emulsion polymerization process, the colorant is dispersed using the reactive emulsifying agent. A monomer, wax, etc. are then added and the resultant mixture is polymerized to prepare a latex particle containing a colorant and wax. The latex particle is used to prepare a toner. The adverse effects of the toner properties normally caused by the remaining emulsifying agents inside the toner are minimized by this process.

The present invention does not use a conventional emulsifying agent during the dispersion of colorant, but instead uses a reactive emulsifying agent. The reactive emulsifying agent anchors to latex resins during the reaction of particle configuration. The toner properties can be improved by this process since there is no migration of remaining emulsifying agent.

Since the present invention does not use a conventional emulsifying agent used for emulsion polymerization, a cleaning process during separation and filtration processes of the toner particles prepared can be minimized. Thus, the preparation process is simplified, production cost is reduced, and generation of polluted water and waste water is decreased, which is very advantageous environmentally. In addition, characteristics such as low friction electric charge and low toner storage stability can be improved and image deterioration due to the emulsifying agents can be prevented.

The reactive emulsifying agent includes a polyoxyethylene alkylphenyl ether moiety and at least one material selected from anionic reactive emulsifying agents having at least one group selected from the group a vinyl group, an acrylate group, and a methacrylate group.

The weight average molecular weight of the reactive emulsifying agent may be in the range of about 100 to about 1,000. When the weight average molecular weight of the reactive emulsifying agent is less than 100, the function of the emulsifying agent is reduced and when it exceeds 1,000, the reactivity thereof is low.

The amount of the reactive emulsifying agent may be in the range of about 5 to about 50 parts by weight, and preferably, in the range of about 10 to about 20 parts by weight based on 100 parts by weight of the colorant. When the amount of the reactive emulsifying agent is less than 5 parts by weight, the dispersibility of the colorant and latex are reduced and particle configuration deteriorates. When the amount of emulsifying agents exceeds 50 parts by weight, the reactivity of the emulsifying agent to the monomer is low.

The reactive emulsifier, as known in the art, contains a reactive group, a hydrophilic group and a hydrophobic group. The reactive group can be a radical polymerizable unsaturated bond, such as a vinyl group, an acrylate group, or methacrylate group. The hydrophilic group can be a polyethylene oxide, hydroxyl, carboxyl, sulfonic acid, sulfuric acid or amino group. The hydrophobic group can be an alky, phenyl, fluoroalkyl, or polysiloxane group. Examples of reactive emulsifiers can have an allyl ether group, a polyethylene oxide group, and a nonylphenyl group such as those sold by Adeka Reasoap under the tradenames NE-10, NE-20 and NE-30. Other examples of reactive emulsifiers have an allyl ether group, a polyethylene oxide group, a sulfuric acid group and a nonylphenyl group from Asahi Denka Kogyo K.K., a propenyl group on a phenyl group in a polyoxyethylene nonyl phenyl ether group, and a propenyl group on a phenyl group in a polyoxyethylene nonyl phenyl ether sulfate ester group from Dai-ichi Kogyo Seiyaku Co., Ltd. Another example has an allyl group and a sulfonic acid group by Kao Corporation. Still other examples are available from Nippon Ngukazai Co., Ltd. including bis(polyoxyethylene polycyclic phenyl ether) methacrylate sulfate ester salt, polyoxythyline nonyl phenyl ether acrylates, polyoxyethylene alkyl ether methacrylates and polyoxyethylene methacrylate esters. Another example is a polyoxyethylene alkylphenyl ether ammonium sulfate.

The method of preparing the toner according to the present invention will now be explained in detail. The reaction emulsifying agent and the colorant are put into ultra-high pure water and dispersed by a disperser. As the disperser, an ultrasonic homogenizer, a bead milling machine, and a microfluidizer may be used. The dispersed aqueous colorant is injected and stirred in the reactor where an appropriate amount of water and nitrogen gas is purged. To control the degree of ionization of the reactive medium, an electrolyte such as NaCl or other ionic salt may be added. When the temperature inside the reactor reaches an appropriate value, an organic solvent, i.e., a mixture of at least one polymerizable monomer and a macromonomer, is injected in the reactor semicontinuously. During this time, a wax and a chain transfer agent may be injected together. The amount and the time of injection of each material are controlled according to the reaction time of the monomer and the macromonomer. The injected monomer diffuses from the center of the colorant dispersed in the reactive emulsifying agent, and the dispersed particles of colorant swell and form droplets of monomer including the colorant. When the dispersed particles of the colorant swell appropriately, a water soluble free radical initiator may be injected to initiate a radical reaction.

The present invention stabilizes the particles during the reaction or after the reaction using a macromonomer.

The macromonomer according to the present invention is an amphipathic material having both a hydrophilic group and a hydrophobic group, and a polymer or an oligomer having at least one reactive functional group. The hydrophilic group reacts with a medium which improves the water dispersion of the monomer, and the hydrophobic group promotes the emulsion polymerization by lying on the surface of toner particles. The macromonomer can form a copolymer by binding with a polymerizable monomer in the toner composition in various ways, such as grafting, branching or cross-linking. By using the macromonomer according to an embodiment of the present invention, the durability and anti-offset of toner particles can be improved. Also, the macromonomer can act as a stabilizer by forming stabilized micelles during the emulsion polymerization.

The weight average molecular weight of the macromonomer is in the range of 100 to 100,000, and preferably in the range of 1,000 to 10,000. When the weight average molecular weight of the macromonomer is less than 100, the properties of the toner may not be improved or the macromonomer may not operate properly as a stabilizer. Also, when the weight average molecular weight of the macromonomer is greater than 100,000, a reaction conversion rate may be low.

The macromonomer according to the present invention may be, for example, a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate and polyester methacrylate, but is not limited thereto.

The amount of the macromonomer used in the present invention may be in the range of about 1 to about 50 parts by weight based on 100 parts by weight of the toner composition. When the amount of the macromonomer is less than 1 part by weight based on 100 parts by weight of the toner composition, the stability of the particle distribution is low. When the amount of the macromonomer exceeds 50 parts by weight based on 100 parts by weight of the toner composition, the property of the toner deteriorates.

The polymerizable monomer used in the present invention is a material having at least one unsaturated group. The polymerizable monomer can be a monomer selected from the group consisting of a vinyl monomer, a polar monomer having a carboxyl group, a monomer having an unsaturated polyester group and a monomer having a fatty acid group.

The polymerizable monomer may be formed of at least one material selected from the group consisting of styrene-based monomer such as styrene, vinyltoluene, and α-methylstyrene; acrylic acid and methacrylic acid; (meth)acrylic acid derivative such as methylacrylate, ethylacrylate, propylacrylate, butylacrylate, 2-ethylhexylacrylate, dimethylaminoethylacrylate, methylmethacrylate, ethylmethacrylate, propylmethacrylate, butylmethacrylate, 2-ethylhexylmethacrylate, dimethylaminoethylmethacrylate; (meth)acrylic acid derivative of an amide selected from the group consisting of acrylonitrile, methacrylonitrile, acrylamide and methacrylamide; ethylenically unsaturated monoolefin such as ethylene, propylene and butylene; halogenated vinyl such as vinyl chloride, vinylidene chloride and vinyl fluoride; vinyl ester such as vinyl acetate and vinyl propionate; vinyl ether such as vinyl methyl ether and vinyl ethyl ether; vinyl ketone such as vinyl methyl ketone and methyl isopropenyl ketone; vinyl compound having nitrogen such as 2-vinyl pyridine, 4-vinyl pyridine and N-vinyl pyrrolidone, but is not limited thereto.

The amount of the polymerizable monomer used in the present invention is in the range of about 3 to about 50 parts by weight based on 100 parts by weight of the toner composition. When the amount of the polymerizable monomer is less than 3 parts by weight based on 100 parts by weight of the toner composition, the yield is low. When the amount of the polymerizable monomer exceeds 50 parts by weight based on 100 parts by weight of the toner composition, the stability of the toner composition is low.

The medium used in the present invention may be an aqueous solution or a mixture of water and an organic solvent.

An amphipathic macromonomer can act not only as a comonomer but also as a stabilizer. The reaction between initial radicals and monomers forms oligomer radicals, and provides an in situ stabilizing effect. The initiator decomposed by heat forms a radical, and reacts with a monomer unit in an aqueous solution to form an oligomer radical, and increases hydrophobicity. The hydrophobicity of the oligomer radical accelerates the diffusion inside the micelle, accelerates the reaction with polymerizable monomers and facilitates a copolymerization reaction with a macromonomer.

Owing to the hydrophilicity of an amphipathic macromonomer, a copolymerization reaction can more easily occur in the vicinity of the surface of the toner particles. The hydrophilic portion of the macromonomer located on the surface of the particle increases the stability of the toner particle by providing steric stability, and can control the particle size according to the amount or molecular weight of the injected macromonomer. Also, the functional group which reacts on the surface of the particle can improve the frictional electricity properties of the toner.

Radicals in the toner composition are formed by the initiator, and the radical may react with the polymerizable monomer. The radical reacts with the polymerizable monomer and the reactive functional group of the macromonomer to form a copolymer.

Examples of the radical polymerized initiator include persulfates, such as potassium persulfate, ammonium persulfate, etc.; azo compounds, such as 4,4-azobis(4-cyanovaleric acid), dimethyl-2,2′-azobis(2-methylpropionate), 2,2-azobis(2-amidinopropane) dihydrochloride, 2,2-azobis-2-methyl-N-1,1-bis (hydroxymethyl)-2-hydroxyethylpropionamide, 2,2′-azobis(2,4-dimethylvaleronitrile), 2,2′-azobisisobutyronitrile, 1,1′-azobis(1-cyclohexanecarbonitrile), etc.; peroxides, such as methylethylperoxide, di-t-butylperoxide, acetylperoxide, dicumylperoxide, lauroylperoxide, benzoylperoxide, t-butylperoxide-2-ethylhexanoate, di-isopropylperoxydicarbonate, di-t-butylperoxyisophthalate, etc. Also, an oxidation-reduction initiator, which is a combination of a polymerized initiator and a reducing agent, may be used.

A developer according to the present invention may include a colorant, and such a colorant may be carbon black or aniline black in the case of a black toner. Also, it is easy to produce a color toner with a nonmagnetic toner according to an embodiment of the present invention. In the case of a color toner, carbon black is used as a colorant for black, and a yellow colorant, a magenta colorant and a cyan colorant are further included as colorants for the colors.

The yellow colorant may be a condensed nitrogen compound, an isoindolinone compound, an anthraquinone compound, an azo metal complex, or an aryl imide compound. For example, C.I. pigment yellow 12, 13, 14, 17, 62, 74, 83, 93, 94, 95, 109, 110, 111, 128, 129, 147, 168, 180, etc. may be used.

The magenta colorant may be a condensed nitrogen compound, anthraquinone, a quinacridone compound, a lake pigment of basic dye, a naphthol compound, a benzoimidazole compound, a thioindigo compound, or a perylene compound. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, etc. may be used.

The cyan colorant may be a copper phthalocyanine compound or a derivative thereof, an anthraquinone compound, or a lake pigment of basic dye. For example, C.I. pigment blue 1, 7, 15, 15:1, 15:2, 15:3, 15:4, 60, 62, 66, etc. may be used.

These colorants may be used alone or in combinations of two or more types. A desired colorant is selected considering the color, saturation, brightness, weatherability, and dispersability in a toner.

The amount of the colorant may be in the range of 0.1 to 20 parts by weight based on the 100 parts by weight of a polymerizable monomer. The amount of the colorant is not particularly limited as long as it is sufficient to color the toner. When the amount of the colorant is less than 0.1 parts by weight, the coloring is insufficient. When the amount of the colorant exceeds 20 parts by weight, the production costs of the toner increases and the toner is unable to obtain enough triboelectric charge.

The toner composition according to the present invention may include at least one material selected from the group consisting of wax, a charge control agent and a release agent.

The release agent protects a photoreceptor and prevents deterioration of the developing properties, and thus may be used for the purpose of obtaining a high quality image. A release agent according to an embodiment of the present invention may use a solid fatty acid ester material with a high purity. For example, a low molecular weight polyolefin, such as low molecular weight polyethylene, low molecular weight polypropylene, low molecular weight polybutylene, etc.; paraffin wax; or a multifunctional ester compound, etc. may be used. The release agent used in an embodiment of the present invention may be a multifunctional ester compound formed of an alcohol having at least three functional groups and carboxylic acid.

The charge control agent may be formed of a material selected from the group consisting of a salicylic acid compound containing a metal, such as zinc or aluminum, a boron complex of bisdiphenylglycolic acid, and silicate. More particularly, dialkyl salicylic acid zinc or borobis(1,1-diphenyl-1-oxo-acetyl potassium salt) may be used.

A suitable wax which provides a desired characteristic of the final toner compound may be used. The wax may be polyethylene wax, polypropylene wax, silicon wax, paraffin wax, ester wax, carnauba wax or metallocene wax, but is not limited thereto. The melting point of the wax may be in the range of about 50 to about 150° C. The wax components physically adhere to the toner particles, but do not covalently bond with the toner particles. The toner fixes to a final image receptor at a low fixation temperature and has a superior final image durability and an antiabrasion property.

The polymerizing reaction may be performed for 3 to 12 hours according to the temperature. Particles obtained as a product of the reaction are filtered, separated and dried. At this time, an agglomeration process may be performed to control the particle size. An additive may be further added to the dried toner for use in a laser printer. The average volumetric particle size of the toner prepared according to the present invention may be in the range of 0.5 to 20 μm, and preferably, in the range of 5 to 10 μm.

The present invention provides a toner including a copolymer of a macromonomer and a polymerizable monomer obtained by emulsion-polymerizing a toner composition in a medium, the toner composition including the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

A radical formed by an initiator reacts with the polymerizable monomer, and the reactive functional group of the macromonomer, and may form a copolymer. The copolymer may be formed by copolymerizing at least one monomer selected from the group consisting of a vinyl monomer, a polar monomer having a carboxyl group, a monomer having an unsaturated polyester group and a monomer having a fatty acid group. The weight average molecular weight of the copolymer may be in the range of about 2,000 to about 200,000.

The weight average molecular weight of the macromonomer may be in the range of about 100 to about 100,000, and is preferably in the range of about 1,000 to about 10,000. The macromonomer may be formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified acrylate and polyester methacrylate, but is not limited thereto.

The average volumetric particle size of the toner particles may be in the range of 0.5 to 20 μm and preferably in the range of 5 to 10 μm.

The toner composition may further include at least one material selected from the group consisting of wax, a charge control agent and a release agent, the details of which are as described above.

The present invention also provides an image forming method including: forming a toner image by disposing a toner on an photoreceptor surface where an electrostatic latent image is formed; and transferring the toner image to a transfer medium, wherein the toner includes a copolymer of a macromonomer and a polymerizable monomer obtained by emulsion-polymerizing a toner composition in a medium, the toner composition including the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

An electrophotographic image forming process includes a charging process, a light-exposing process, a developing process, a transferring process, a fixing process, a cleaning process and an antistatic process, which are carried out in a series to form an image on an image receptor.

In the charging process, the photoreceptor is covered with electric charges of desired polarity, either negative or positive, by a corona or a charging roller. In the light-exposing process, an optical system, generally a laser scanner or an array of diodes, forms a latent image corresponding to a final visual image to be formed on an image receptor by selectively discharging the charging surface of the photoreceptor in an imagewise manner. Electromagnetic radiation (hereinafter, “light”) may include infrared radiation, visible rays and ultraviolet radiation.

In the developing process, in general, the toner particles with suitable polarity contact the latent image on the photoreceptor. Typically, an electrically biased developer having a potential with the same polarity as the toner is used. The toner particles move to the photoreceptor, selectively adhere to the latent image through static electricity and form a toner image on the photoreceptor.

In the transferring process, the toner image is transferred from the photoreceptor to a desired final image receptor. Sometimes an intermediate transferring element is used to effect the transfer of the toner image from the photoreceptor to the final image receptor.

In the fixing process, the toner image is fixed to the final image receptor by melting or softening the toner particles by heating the toner image on the final image receptor. Alternatively, the toner can be fixed to the final image receptor under high pressure while being heated or unheated. In the cleaning process, the toner particles remaining on the photoreceptor are removed. In the antistatic process, an electric charge on the photoreceptor is exposed to light of a certain wavelength, and the electric charge is substantially decreased to a uniform low value. Consequentially, a residue of the latent image is removed and the photoreceptor is prepared for the image forming cycle.

The present invention also provides an image forming apparatus including: an organic photoreceptor; a unit for electrifying the surface of the organic photoreceptor; a unit for forming an electrostatic latent image on the surface of the organic photoreceptor; a unit containing a toner, a unit for supplying the toner to the surface of the organic photoreceptor to develop the electrostatic latent image into a toner image; and a unit for transferring the toner image on the organic photoreceptor to a transfer medium. The toner used in the image forming apparatus is a toner containing a copolymer of a macromonomer and a polymerizable monomer obtained by emulsion-polymerizing a toner composition in a medium, the toner composition including the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

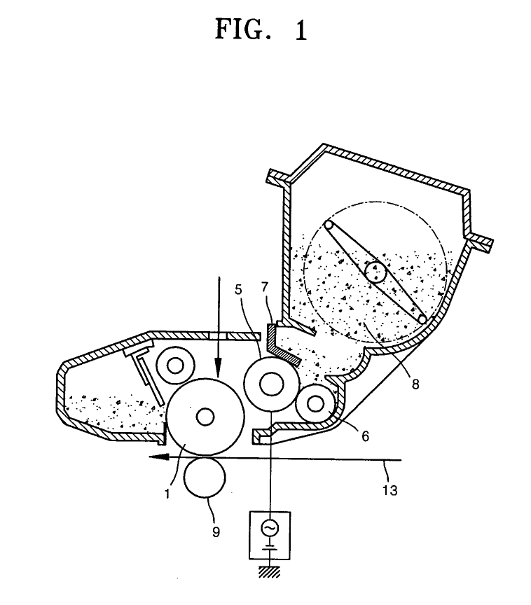

FIG. 1 is a schematic diagram of a non-contact developing type image forming apparatus using a toner prepared using the method according to an embodiment of the present invention. The operating principles of the image forming apparatus are explained below.

A developer 8, which is a nonmagnetic one-component developer, is supplied to a developing roller 5 through a feeding roller 6 formed of an elastic material such as polyurethane or a foam or sponge material. The developer 8 supplied to the developing roller 5 reaches a contact point between the developing roller 5 and a developer regulation blade 7 as the developing roller 5 rotates. The developer regulation blade 7 is formed of an elastic material such as metal, rubber, etc. When the developer 8 passes the contact point between the developing roller 5 and the developer regulation blade 7, the developer 8 is smoothed to form a thin layer and the developer 8 is sufficiently charged. The developing roller 5 transfers the thin layer of the developer 8 to a developing domain where the developer 8 is developed on the electrostatic latent image of a photoreceptor 1, which is a latent image carrier.

The developing roller 5 and the photoreceptor 1 face each other with a constant distance therebetween without contact. The developing roller 5 rotates counterclockwise and the photoreceptor 1 rotates clockwise. The developer 8 transferred to the developing domain forms an electrostatic latent image on the photoreceptor 1 according to the intensity of an electric charge generated due to a difference between a voltage applied to the developing roller 5 and a latent image potential of the photoreceptor 1.

The developer 8 developed on the photoreceptor 1 reaches a transferring device 9 as the photoreceptor 1 rotates. The developer 8 developed on the photoreceptor 1 is transferred through corona discharging or by a roller to a printing paper 13 as the printing paper 13 passes between the photoreceptor 1 and the transferring device 9 by the transferring device 9 to which a high voltage with an opposite polarity to the developer 8 is applied, and thus forms an image.

The image transferred to the printing paper 13 passes through a fusing device (not shown) that provides high temperature and high pressure to fuse the image to the printing paper 13 as the developer 8 is fused to the printing paper 13. Meanwhile, remaining developer 8 on the developing roller 5 which is not developed is taken back by the feeding roller 6 contacting the developing roller 5. The above process steps are repeated.

The present invention will now be described in greater detail with reference to the following examples. The following examples are for illustrative purposes only and are not intended to limit the scope of the invention.

### EXAMPLES

### Example 1

16 g of cyan pigment, PB15:3 and 4 g of reactive emulsifying agent, HS-10 (available from DAI-ICHI KOGYO) were mixed in 100 g of ultra-high pure water which was deoxidized by ultra-high pure nitrogen. The mixture was introduced into a dispersing mixer (Dispermat Milling) and rotated at 5,000 RPM for about an hour to prepare colorant dispersion. An aqueous solution was prepared by mixing 500 g of ultra-high pure water and 5 g of polyethyleneglycol methacrylate (PEG-MA) and introduced into the reactor. 50 g of the pigment solution obtained by the above process was diluted in 600 g of ultra-high pure water and homogenized in a one liter reactor. The homogenization time was two minutes at a rotation of 7,000 RPM. After the homongenization, the pigment solution was stirred at 300 RPM and heated to 80° C. When the temperature inside the reactor reached the appropriate value, 1 g of potassium persulfate and 0.5 g of 2,2′-azobisisobutyronitrile were added as an initiator, and the reactor was purged with nitrogen gas. Immediately, a monomer compound formed of 100 g of monomer mixture of styrene, butylacrylate, methylacrylate and PEG-MA at the rate of 7:1.5:0.5:1 respectively, 2.5 g of chain transfer agent, 1-dodecanethiol and 10 g of release agent, ester wax were introduced slowly using a dropwise adding funnel for about an hour. During this process, the reaction time was 3 hours, and after that, 2 g of NaCl was dissolved in 20 g of ultra-high pure water and dropwise added to the reactor. Again, 110 g of the monomer mixture of above rate was introduced for an hour. The total reaction time was 6 hours and after the reaction, the product was naturally cooled while stirring. The average volumetric particle size of obtained particles was 5.8 μm.

### Example 2

A toner composition was prepared in the same manner as in Example 1 except that, after 2 hours of the reaction time, a mixture of 15 g of styrene, 3 g of butylacrylate, 0.5 g of methylacrylate, 0.5 g of PEG-MA, and 2.5 g of dodecanethiol as a monomer for a shell layer was added. The reaction time was 6 hours, and the temperature was maintained at 80° C. during the reaction. After 6 hours, the heat was discontinued and the reactor was allowed to cool naturally. The average volumetric particle size of particles was 6.9 μm and the number average size was 6.9 μm.

### Example 3

A toner composition was prepared in the same manner as in Example 1 except that, 6 g of PZ-141 (Rhodia) was used instead of HS-10. Also, instead of ester wax, 8 g of polyethylene wax was used. The average volumetric particle size of the particles manufactured was 6.3 μm and the number average size was 6.1 μm

### Example 4

A toner composition was prepared in the same manner as in Example 1 except that, PEG-ethyl ether methacrylate (EEMA) was used instead of PEG-MA. Also, instead of 10 g of ester wax, 11 g of polyethylene wax was used. The average volumetric particle size of the particles manufactured was 6.8 μm and the number average size was 6.5 μm.

### Example 5

A toner composition was prepared in the same manner as in Example 1 except that, PEG-hydroxyethyl methacrylate was used instead of PEG-MA. The PEG-hydroxyethyl methacrylate was dissolved in 10 g of ethanol and then in water. The average volumetric particle size of the particles manufactured was 6.8 μm.

### Example 6

A toner composition was prepared in the same manner as in Example 1 except that, acrylic acid was used instead of methacrylic acid. The average volumetric particle size of the particles manufactured was 6.8 μm and the number average size was 6.5 μm.

### Example 7

A toner composition was prepared in the same manner as in Example 1 except that, PY 180 was used instead of PB 15:3 for the pigment. The average volumetric particle size of the particles manufactured was 7.1 μm and the number average size was 6.9 μm.

### Example 8

A toner composition was prepared in the same manner as in Example 1 except that, PR122 was used instead of PB 15:3 for the pigment. The average volumetric particle size of the particles manufactured was 7.3 μm and the number average size was 7.1 μm.

### Example 9

A toner composition was prepared in the same manner as in Example 1 except that, carbon black (Nipex 70) was used instead of PB 15:3 for the pigment. The average volumetric particle size of the particles manufactured was 6.7 μm and the number average size was 6.5 μm.

### Comparative Example

### Conventional Emulsion/Aggregation Process

Preparation of Latex

0.5 g of sodium dodecyl sulfate (SDS) as an anionic surfactant, was mixed in 400 g of ultra-high pure water that was deoxidized. The aqueous solution was put into a reactor and heated to 80° C. When the temperature reached 80° C., an initiator, which was a solution of 0.2 g of potassium persulfate in 30 g of ultra-high pure water, was added. After 10 minutes, 105.5 g of styrene, butylacrylate and methacrylic acid (each 81 g, 22 g, 2.5 g respectively) were dropwise added for about 30 minutes. After allowing a reaction to occur for 4 hours, the heating was stopped and the product was allowed to cool naturally. 30 g of the resultant seed solution was removed and added to 351 g of ultra-high pure water, and the result was heated to 80° C. 17 g of ester wax was heated and dissolved together with 18 g of monomer styrene, 7 g of butylacrylate, 1.3 g of methacrylic acid, and 0.4 g of dodecanethiol. The prepared wax/mixed monomer was added to 220 g of ultra-high pure water in which 1 g of SDS was dissolved, and the result was homogenized for about 10 minutes in an ultrasonic homogenizer. The homogenized emulsified solution was put into the reactor and after about 15 minutes, 5 g of the initiator and 40 g of ultra-high pure water were mixed and added to the reactor. During this time, the reaction temperature was maintained at 82° C. and the reaction was allowed to continue thereafter for about 2 hours and 30 minutes. After the reaction was performed for 2 hours and 30 minutes, 1.5 g of the initiator and 60 g of ultra-high pure water were again added together with a monomer for shell layer formation. The monomer was composed of 56 g of styrene, 20 g of butylacrylate, 4.5 g of methacrylic acid, and 3 g of dodecanethiol. The monomer was dropwise added to the reactor for about 80 minutes. After the reaction was performed for two hours, the reaction was stopped and the product was allowed to cool naturally.

Toner Aggregation/Melting Process

318 g of latex particles prepared as described above were mixed with ultra-high pure water in which 0.5 g of an SDS emulsifier was dissolved. 18.2 g of pigment particles (cyan 15:3, 40 solidity %) dispersed by the SDS emulsifier were added to obtain a latex pigment dispersed aqueous solution. While stirring at 250 RPM, the pH of the latex pigment dispersed aqueous solution was titrated to pH 10 using a 10% NaOH buffer solution. 30 g of ultra-high pure water was dissolved in 10 g of MgCl₂ as an aggregating agent, and the result was added dropwise to the latex pigment aqueous solution for about 10 minutes. The temperature of the result was increased to 95° C. at a rate of 1° C./min. After about 3 hours of heating, the reaction was stopped and the product was allowed to cool naturally. The average volumetric particle size was about 6.5 μm.

According to the present invention, by using the reactive emulsifying agent, the cleaning process is simplified, and generation of polluted water and waste water is decreased, which is very advantageous environmentally. The formation and size of toner particles can be easily controlled. The anti-offset properties, triboelectric charge properties and storage stability of the toner are superior and allow the realization of high quality images. Also, a polymerized toner with superior properties can be prepared under a high humidity condition.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner, comprising:
preparing a colorant dispersion by mixing a reactive emulsifying agent and a colorant;
preparing a toner composition by mixing a macromonomer having a hydrophilic group, a hydrophobic group and at least one reactive functional group, at least one polymerizable monomer, and the colorant dispersion;
emulsion polymerizing the toner composition in a medium; and
separating and drying the polymerized toner.

2. The method of claim 1, wherein the reactive emulsifying agent comprises a polyoxyethylene alkylphenyl ether moiety and at least one material selected from anionic reactive emulsifying agents having at least one group selected from the group a vinyl group, an acrylate group, and a methacrylate group.

3. The method of claim 1, wherein the weight average molecular weight of the reactive emulsifying agent is in the range of about 100 to about 1,000.

4. The method of claim 1, wherein the amount of the reactive emulsifying agent is in the range of about 5 to about 50 parts by weight based 100 parts by weight of the colorant.

5. The method of claim 1, wherein the amount of the reactive emulsifying agent is in the range of about 10 to about 20 parts by weight based on 100 parts by weight of the colorant.

6. The method of claim 1, wherein the weight average molecular weight of the macromonomer is in the range of about 500 to about 100,000.

7. The method of claim 1, wherein the macromonomer is formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate, and polyester methacrylate.

8. The method of claim 1, wherein the amount of the macromonomer is in the range of about 1 to about 50 parts by weight based on 100 parts by weight of the toner composition.

9. The method of claim 1, wherein the polymerizable monomer comprises at least one monomer selected from the group consisting of a vinyl monomer, a polar monomer having a carboxyl group, a monomer having an unsaturated polyester group, and a monomer having a fatty acid group.

10. The method of claim 1, wherein the polymerizable monomer comprises at least one material selected from the group consisting of a styrene-based monomer selected from the group consisting of styrene, vinyltoluene, and α-methylstyrene; acrylic acid; methacrylic acid; a (meth)acrylic acid derivative selected from the group consisting of methylacrylate, ethylacrylate, propylacrylate, butylacrylate, 2-ethylhexylacrylate, dimethylaminoethylacrylate, methylmethacrylate, ethylmethacrylate, propylmethacrylate, butylmethacrylate, 2-ethylhexylmethacrylate, and dimethylaminoethylmethacrylate; a (meth)acrylic acid derivative of amide selected from the group consisting of acrylonitrile, methacrylonitrile, acrylamide and methacrylamide; an ethylenically unsaturated monoolefin selected from the group consisting of ethylene, propylene and butylene; a halogenated vinyl selected from the group consisting of vinyl chloride, vinylidene chloride and vinyl fluoride; a vinyl ester selected from vinyl acetate and vinyl propionate; a vinyl ether selected from vinyl methyl ether and vinyl ethyl ether; a vinyl ketone selected from the group consisting of vinyl methyl ketone and methyl isopropenyl ketone; and a vinyl compound having nitrogen selected from the group consisting of 2-vinyl pyridine, 4-vinyl pyridine and N-vinyl pyrrolidone.

11. The method of claim 1, wherein the amount of the polymerizable monomer is in the range of about 3 to about 50 parts by weight based on 100 parts by weight of the toner composition.

12. The method of claim 1, wherein the colorant comprises a material selected from the group consisting of yellow, magenta, cyan and black pigments.

13. The method of claim 1, wherein a radical is generated from the toner composition by an initiator and the radical reacts with the polymerizable monomer.

14. The method of claim 1, where in the toner composition further comprises at least one material selected from the group consisting of wax, a chain transfer agent, a charge control agent, and a release agent.

15. A toner comprising a copolymer of a macromonomer and a polymerizable monomer obtained by emulsion-polymerizing a toner composition in a medium, the toner composition comprising the macromonomer having a hydrophilic group, a hydrophobic group and at least one reactive functional group, at least one polymerizable monomer, and a colorant dispersion, wherein the colorant dispersion is prepared by mixing a reactive emulsifying agent and a colorant.

16. The toner of claim 15, wherein the copolymer is formed by copolymerizing at least one monomer selected from the group consisting of a vinyl monomer, a polar monomer having a carboxyl group, a monomer having unsaturated polyester, and a monomer having a fatty acid group.

17. The toner of claim 15, wherein the weight average molecular weight of the copolymer is in the range of about 2,000 to about 200,000.

18. The toner of claim 15, wherein the average volumetric particle size of the toner particle is in the range of about 0.5 to about 20 μm.

19. The toner of claim 15, wherein the weight average molecular weight of the macromonomer is in the range of about 100 to about 100,000.

20. The method of claim 15, wherein the macromonomer is formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified acrylate, and polyester methacrylate.

21. The toner of claim 15, wherein the toner composition further comprises at least one material selected from the group consisting of wax, a charge control agent, and a release agent.

22. A method of forming an image comprising:
forming a toner image by disposing the toner of claim 15 on an photoreceptor surface having an electrostatic latent image thereon; and
transferring the toner image to a transfer medium.

23. An image forming apparatus comprising:
an organic photoreceptor;
a unit for electrifying a surface of the organic photoreceptor;
a unit for containing the toner of claim 15;
a unit for supplying the toner to the surface of the organic photoreceptor to develop an electrostatic latent image on the surface of the organic photoreceptor into a toner image; and
a unit for transferring the toner image on the surface of the organic photoreceptor to a transfer medium.

24. A method of preparing a toner, comprising:
emulsion polymerizing a toner composition including a colorant dispersion, a macromonomer and at least one polymerizable monomer, wherein the colorant dispersion comprises a reactive emulsifying agent and a colorant and the macromonomer has a hydrophilic group, a hydrophobic group and at least one reactive functional group; and
separating and drying the resulting polymerized toner.

25. The method of claim 24, wherein the reactive emulsifier comprises a polyoxyethylene alkylphenyl ether moiety and at least one material selected from anionic reactive emulsifying agents having at least one group selected from the group a vinyl group, an acrylate group, and a methacrylate group.
